(19) United States
(12) Patent Application Publication
(10) Pub. No.: US 2023/0397684 A1
(43) Pub. Date: Dec. 14, 2023

(54) WEARABLE BATTERY SYSTEM

(71) Applicant: The Johns Hopkins University, Baltimore, MD (US)

(72) Inventors: Matthew G. Bevan, Silver Spring, MD (US); Kenneth R. Grossman, Olney, MD (US); Jason E. Tiffany, Columbia, MD (US); Jessica E. Harsono, Rockville, MD (US)

(21) Appl. No.: 18/131,490

(22) Filed: Apr. 6, 2023

Related U.S. Application Data
(60) Provisional application No. 63/350,886, filed on Jun. 10, 2022.

(51) Int. Cl. A42B 3/04; A42B 3/30

(52) U.S. Cl. CPC A42B 3/0406; A42B 3/30

(57) ABSTRACT

A helmet system includes a helmet shell and a battery interface. The battery interface may be disposed on an exterior of a rear portion of the helmet shell. The battery interface may include a base, a mechanical latch feature, and a magnetic latch feature. The mechanical latch feature may be configured to interface with a complementary mechanical feature of the battery to contribute to a releasable maintenance of the battery within the battery receiving slot. The magnetic latch feature may be configured to interface, via a magnetic bias, with a complementary magnetic feature of the battery to contribute to the releasable maintenance of the battery within the battery receiving slot.

### CROSS-REFERENCE TO RELATED APPLICATIONS

This application claims priority to and the benefit of prior-filed, U.S. Provisional Application No. 63/350,886 filed on Jun. 10, 2022, the entire contents of which are hereby incorporated herein by reference.

### STATEMENT OF GOVERNMENTAL INTEREST

This invention was made with Government support under contract number N00024-13-D-6400 awarded by the Naval Sea Systems Command (NAVSEA). The Government has certain rights in the invention.

### TECHNICAL FIELD

Exemplary embodiments generally relate to wearable electronic technology, and more specifically, relate to power and data systems and apparatuses that may be supported by headwear, such as a helmet.

### BACKGROUND

As advanced processors, sensors, and communications devices continue to see reductions in size, previously unwieldy devices have become quite portable. With portability, comes demands for such devices to be wearable by being coupled to articles of clothing or other wearable accessories. Many new electronic devices are being designed as head-mounted solutions that provide visual and audible interfaces to a user. Such devices, in the form of, for example, heads-up displays and augmented or virtual reality headsets, are finding applications in a wide variety of markets, from consumers to the military. Additionally, accessory devices are also being developed that would be useful, for example, in applications where the device would be affixed to or supported by a helmet. However, physically supporting and powering such accessory devices has proven to be a challenge.

Such wearable devices need a power source, which is typically one or more batteries. For the system to be completely wearable, the batteries also need to be wearable. Further, a distribution system to supply power to helmet-mounted and accessory devices would also need to be wearable. In some applications, such in-the-field military applications, removing the head-mounted device or the helmet to charge batteries is not an option. As such, a battery solution, power distribution system, and device interface is needed that supports head-mounted and other accessory devices, but also allows for convenient and efficient removal and replacement of depleted batteries for replacement with fully-charged batteries.

### BRIEF SUMMARY

According to some example embodiments, a helmet system is provided. The helmet system may include a helmet shell and a battery interface. The helmet shell may include a front portion configured to be positioned adjacent a forehead of a head of a user and a rear portion configured to be positioned adjacent to a back of the head of the use. The battery interface may be disposed on an exterior of the rear portion of the helmet shell. The battery interface may include a base, a mechanical latch feature, and a magnetic latch feature. The battery interface may be disposed adjacent to the rear portion of the helmet shell. The base may include a battery internal side support surface, a battery front support surface, and an electrical connection interface configured to electrically connect to a battery. The battery internal side support surface and the battery front support surface may define a battery receiving slot. The mechanical latch feature may be configured to interface with a complementary mechanical feature of the battery to contribute to a releasable maintenance of the battery within the battery receiving slot. Additionally, the magnetic latch feature configured to interface, via a magnetic bias, with a complementary magnetic feature of the battery to contribute to the releasable maintenance of the battery within the battery receiving slot.

According to some example embodiments, a battery interface apparatus for a wearable device is provided. The battery interface apparatus may include a base, a mechanical latch feature, and a magnetic latch feature. The base may include a battery internal side support surface, a battery front support surface, and an electrical connection interface configured to electrically connect to a battery. The battery internal side support surface and the battery front support surface may define a battery receiving slot. The mechanical latch feature may be configured to interface with a complementary mechanical feature of the battery to contribute to a releasable maintenance of the battery within the battery receiving slot. The magnetic latch feature may be configured to interface, via a magnetic bias, with a complementary magnetic feature of the battery to contribute to the releasable maintenance of the battery within the battery receiving slot.

According to some example embodiments, a method for operating a helmet system for powering helmet-mounted electronic devices is provided. The method may include receiving a battery into a battery receiving slot defined by a battery side support surface and a battery front support surface. The battery side support surface and the battery front support surface may be surfaces of a base of a battery interface disposed on an exterior of a rear portion of a helmet shell. The method may further include mechanically engaging a mechanical latch feature with a complementary mechanical feature of the battery to contribute to a releasable maintenance of the battery within the battery receiving slot, and magnetically biasing the battery into the slot via a magnetic latch feature interfacing with a complementary magnetic feature of the battery to contribute to the releasable maintenance of the battery within the battery receiving slot. The method may further include electrically connecting the battery to an electrical connection interface of the base, and providing electrical power to one or more accessory devices via the electrical connection interface, the one or more accessory devices being supported by the helmet.

### BRIEF DESCRIPTION OF THE SEVERAL VIEWS OF THE DRAWING(S)

Having thus described some non-limiting, example embodiments in general terms, reference will now be made to the accompanying drawings, which are not necessarily drawn to scale, and wherein:

FIG. 1 illustrates a side view of an example helmet with a battery system according to some example embodiments;

FIG. 2 illustrates a perspective rear view of an example helmet with a battery system according to some example embodiments;

FIG. 3 illustrates a top view of an example helmet with an example battery system according to some example embodiments;

FIG. 4 illustrates an interior portion perspective view of an example battery interface according to some example embodiments;

FIG. 5 illustrates an external portion perspective view of an example battery interface according to some example embodiments;

FIG. 6 illustrates an internal side of an example battery according to some example embodiments;

FIG. 7 illustrates an external side of an example battery according to some example embodiments;

FIG. 8 illustrates an example collection of batteries according to some example embodiments;

FIG. 9 illustrates a cross-section view of an example battery receiving slot according to some example embodiments;

FIG. 10 illustrates an example battery front support surface of a battery interface according to some example embodiments;

FIG. 11 illustrates a top, cross-section view of an example battery interface at a depth of a lever arm tab according to some example embodiments;

FIG. 12 illustrates a top, cross-section view of an example battery interface at a depth of an ejection cam according to some example embodiments;

FIG. 13A illustrates a zoomed top, cross-section view of a battery interface at a depth of a lever arm tab with the lever arm in a first position according to some example embodiments;

FIG. 13B illustrates a zoomed top, cross-section view of a battery interface at a depth of an ejection cam with the lever arm in the first position according to some example embodiments;

FIG. 13C illustrates a zoomed top, cross-section view of a battery interface at a depth of a lever arm tab with the lever arm in a second position according to some example embodiments;

FIG. 13D illustrates a zoomed top, cross-section view of a battery interface at a depth of an ejection cam with the lever arm in the second position according to some example embodiments;

FIG. 13E illustrates a zoomed top, cross-section view of a battery interface at a depth of an ejection cam with the lever arm in the third position according to some example embodiments;

FIG. 14 illustrates a perspective rear view of an example slot-based, electrical connection system according to some example embodiments;

FIGS. 15A through 15F illustrate a cross-section side view of an installation and removal process for an example slot connection system according to some example embodiments;

FIG. 16 illustrates a block diagram of a helmet system according to some example embodiments; and

FIG. 17 illustrates an example method for operating a helmet system according to some example embodiments.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. The term “or” as used herein is used as the logical or and therefore refers to each of a collection of options and both or all of the options.

In view of the foregoing, according to some example embodiments, a wearable system, such as a helmet system, including a battery interface in the form of a battery interface apparatus is described. Such a battery interface may be part of a wearable device, such as a helmet, and, in some example embodiments, may be permanently affixed to be an inseparable component of the wearable device. In this regard, according to some example embodiments, the battery interface may include a base, a mechanical latch, and a magnetic latch. Surfaces of the base of the battery interface may define a slot, within which a battery may be received to make an electrical connection and be physically secured.

Because the battery interface may be utilized in a wearable implementation, the battery interface may be configured to operate in a number of challenging, different environments. For example, in a helmet application for military purposes, the battery interface may be subjected to regular impacts and jostling as a user runs or moves through constrained passageways. As such, the battery interface may be configured to secure one or more batteries in a way that avoids to avoid unintended removal and disconnection of the batteries while locked into the battery interface. However, the battery interface may also provide ease of use with respect to replacement of the batteries when a battery has been discharged and installation of a replacement battery is needed. Again, in military applications, a battery replacement operation may be required to be a quick and efficient operation that can be performed by the individual that is, for example, wearing the helmet including the battery interface. Accordingly, the replacement operation may be required to facilitate quick and convenient battery removal, with relatively little effort. Such a requirement is in conflict with a requirement that the battery be securely held, and difficult disconnect, while installed and in use. According to some example embodiments, these competing requirements have been considered to develop embodiments of a robust battery interface for wearable devices that boasts a high physical security for the battery when in a locked, installed state, while also offering low effort, ease of use, and ergonomics for battery replacement.

Additionally, in helmet solutions, neck loading and associated muscle fatigue may also be considered in various example embodiments. In this regard, a variety of helmet-mounted devices, such as heads-up displays and night-vision displays, often add weight to the forehead side of the helmet. An unbalanced weight distribution caused by such devices can create issues such neck loading issues. As such, according to some example embodiments, batteries, which are also a relatively heavy component of an electronic device, may be placed at the rear portion of the helmet to work as a counter-balance to the front portion weight of the helmet. Such positioning can bring the center of gravity back to a more comfortable position for the user and reduce strain on the neck. Additionally, moving the batteries to the rear of the helmet can also reduce the likelihood, in a military context, that projectiles come into contact with the batteries.

Additionally, according to some example embodiments, the battery interface may include or be a component of a larger system that distributes power from the batteries to peripheral receiving ports on a wearable device and also provides a data bus for the powered devices. In this regard, for example, a side rail on a helmet application may include powered ports or slots that may be configured to engage with an accessory device to provide both physical support and electrical power. Such slots may also provide for a data connection. According to some example embodiments, the side rail may be configured to support modular systems, such as MOLLE (MOdular Lightweight Load-carrying Equipment) systems that are commonly used on military backpacks and other wearable gear. Additionally, PALS (Pouch Attachment Ladder System)-type implementations may be integrated into the side rail to provide a standardized support interface for accessory devices. As such, the side rail may include connection slots with an internal connection interface that provides power and also possibly data connections to an accessory device that may be installed in the connection slot. As such, the side rail may be configured to support engagement with a plurality of different modular accessory devices (e.g., lights, sensors, communications devices, etc.) for both power and data. With respect to the data connection, according to some example embodiments, the system may support other functionalities such as additional processing power, memory storage, and wireless communications capabilities that can be leveraged by, for example, an accessory device via the data connection to the connection slots of the side rail.

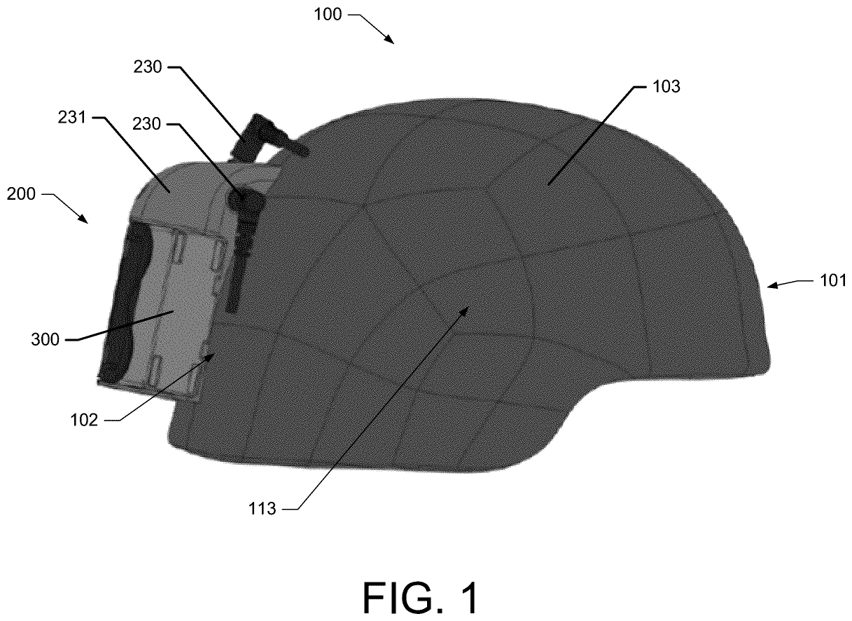

In light of the foregoing, a helmet 100 with a battery interface 200, according to some example embodiments, is illustrated in FIG. 1. FIG. 1 provides a side view of an example helmet 100, according to some example embodiments. The helmet 100 may include a helmet shell 103 and additional components (not shown) to facilitate securing the helmet 100 to the head of a user (e.g., straps, chin cradle, etc.). The helmet shell 103 may be shaped to receive a user's head and may be formed of a material or constructed to protect the user's head from injury. For example, in some construction contexts, the helmet 100 may be formed of a hard plastic or polyurethane with reinforcing ridges. Alternatively, in a military context, the helmet shell 103 may be formed of a material that may inhibit the passage of ballistic projectiles such as metals, alloys, synthetics/fibers such as para-aramid (e.g., KEVLAR®), or the like.

The helmet 100 may have a front portion 101 that would be disposed adjacent to the forehead of the user when the helmet 100 is worn, a rear portion 102 that would be disposed adjacent to the back of the user's head when the helmet 100 is worn, and side portions 113 that are disposed adjacent to the ears of the user when the helmet 100 is worn. As shown in FIG. 1, the battery interface 200 may be disposed on the rear portion 102 of the helmet 100. According to some example embodiments, the rear portion 102 may extend lower on the back of the head than the front portion, thereby offering additional surface area on the rear portion 102 of the helmet 100 to place the battery interface 200. As shown in FIG. 1, the battery interface 200 includes an electronics housing 231 having connectors 230 (only a portion of which are shown) connected thereto. Also, a battery 300 is shown as installed into the battery interface 200.

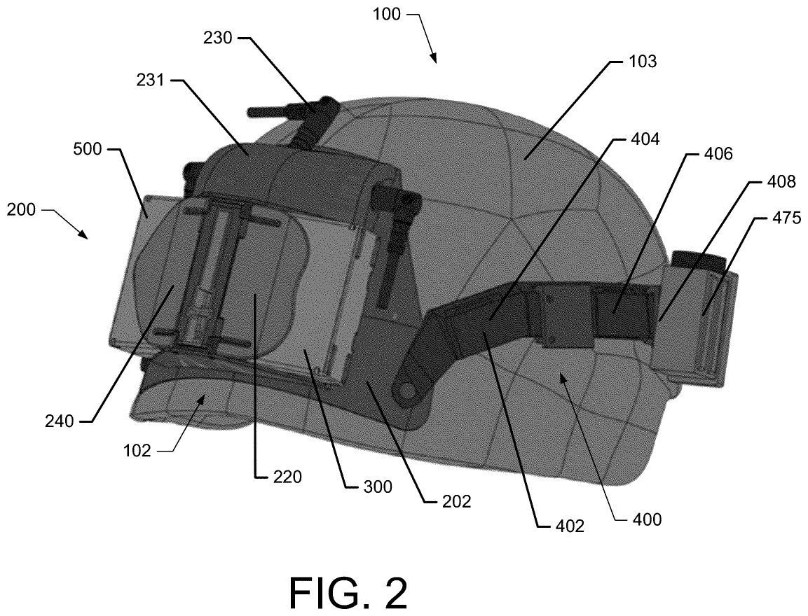

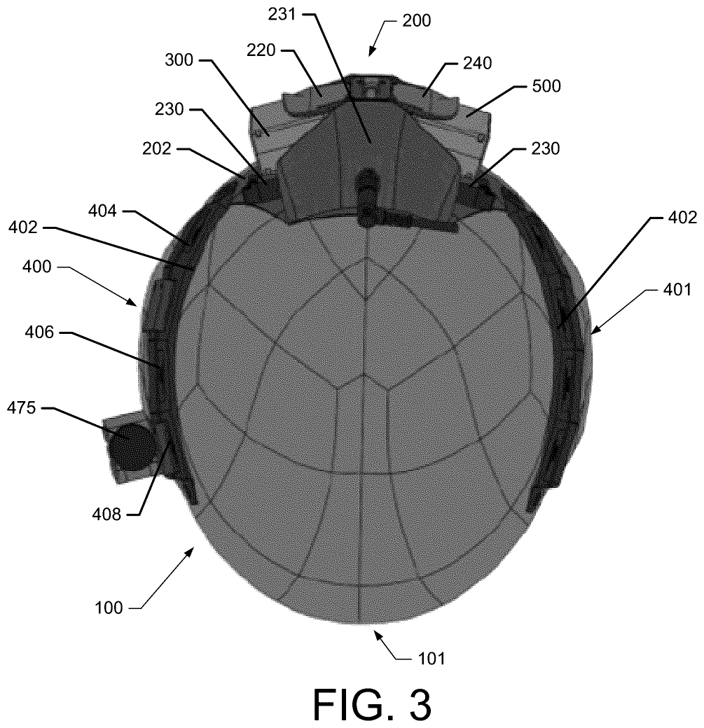

FIGS. 2 and 3 provide a perspective rear view and a top or overhead view, respectively, of the helmet 100 showing additional details of the example battery interface 200. The helmet 100 as shown in FIGS. 2 and 3 also includes two accessory interface members 400 and 401 in the form of the side rails 402 with connection slots 404, 406, and 408. Connection slot 408 has an accessory device 475 installed therein. As can be better seen in FIG. 2, the battery interface 200 may be configured to receive two batteries, i.e., a first battery 300 and a second battery 500. According to some example embodiments, implementations involving at least two batteries may facilitate “hot-swapping” where one battery continues to support the power requirements of a load, while another battery is replaced. As described further below, the batteries 300 and 500 may be received in respective battery receiving slots and secured in place while making an electrical connection to the battery interface 200. The batteries 300 and 500 may be installed adjacent to or in contact with an external surface, referred to as the battery internal side support surface, of a base 202 of the battery interface 200.

Also, as a component of a quick-release mechanism for the batteries 300 and 500, the battery interface 200 may include lever arms 220 and 240. As shown, these lever arms 220 and 240 are ergonomically placed to allow a user wearing the helmet 100 to reach around the back of the helmet 100 to pivot a lever arm to release a respective battery. In this regard, to release the battery 300 on the right side of the battery interface 200 and the rear portion 102, the user may reach with their left hand to engage and pivot the lever arm 220 backwards towards a centerline of the battery interface 200 and the helmet 100. The user may also hold the battery 300 with the user's right hand, while the left hand is pivoting the lever arm 220, and remove the battery 300 from its receiving slot for replacement of a charged battery into the receiving slot. Additionally, as further described below, it can be seen in FIG. 3 that the installed batteries 300 and 500 are not in parallel alignment, but are disposed at an angle. In this regard, the receiving slots for the batteries are angled to better conform to the rounded shape of the helmet shell 103 for a closer fit to the helmet shell 103. As a result, the battery interface 200 is less bulky, relative to one where the batteries are aligned in a plane, providing improved clearance for the helmet 100. Additionally, the angled positioning of the batteries improve the accessibility of the batteries to the user during installation and replacement while the helmet 100 is being worn.

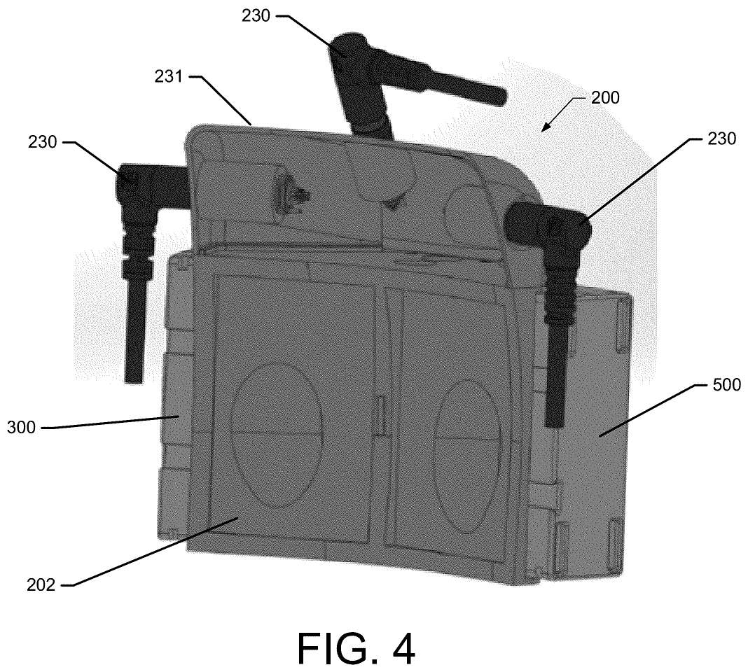

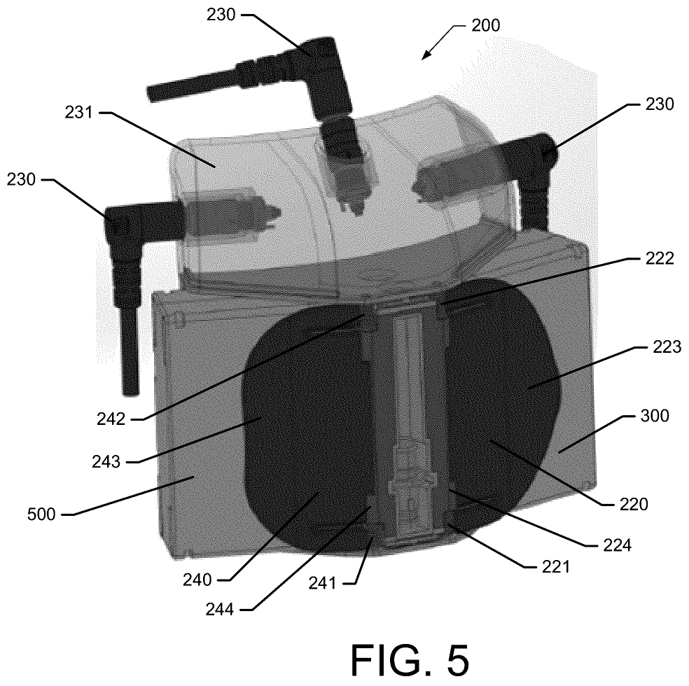

Now referring to FIGS. 4 and 5, the battery interface 200 is shown in isolation from the helmet 100 and the helmet shell 103. In some example embodiments, the battery interface 200 may be a separate component from the helmet 100 and may therefore be removable and replaceable if maintenance is necessary. According to some example embodiments, the battery interface 200 may be integrated into the helmet shell 103 and may therefore be non-separable.

As shown in FIG. 4, which illustrates an interior portion perspective view of the battery interface 200, the battery interface 200 may include a base 202 and an electronics housing 231. The base 202 may have a contoured shape that conforms to the shape of the helmet shell 103 on an interior surface of the base 202. The base 202 may also include a battery internal side support surface (not shown), which is an exterior side of the base 202 that is adjacent to or engages with the batteries 300 and 500. The battery interface 200 may include a battery internal side support surface for each battery and the battery internal side support surface may define one wall of the receiving slots for receiving a respective battery 300 or 500. As such, in example embodiments where the battery interface 200 is configured to receive two batteries, the battery internal side support surfaces may be non-parallel and disposed at an angle to each other (e.g., forming an obtuse angle).

For illustration purposes, the electronics housing 231 is shown as being empty in FIG. 4. However, the electronics housing 231 may house various battery-related circuitry. Additionally, according to some example embodiments, the electronics housing 231 may also include various circuitry to support application-level functionalities such as memory storage, processing, and communications. According to some example embodiments, the battery-related circuitry may include a battery management system (BMS) that is configured to monitor and control the operation of the batteries. For example, the BMS may control currents and voltages that are provided to a load, perform safety operations such as heat management and overcurrent protection, monitor charge levels and provide human-perceivable outputs to indicate the same, and the like. As mentioned previously, connectors 230 may be electrically connected to the battery interface 200 and, more specifically, the electronics housing 231. The connectors 230 (only a portion of which are shown) may be wires or cables that operate to distribute power from the batteries to other locations, for example, on the helmet 100. According to some example embodiments, the connectors 230 may carry power to devices (e.g., peripheral and accessory devices), as well as, support the transmission and receipt of control signals, and data signals to devices, as further described with respect to the connection slots of the side rails for the helmet 100. According to some example embodiments, the connectors 230 may be hardwired between the electronics housing 231 and interfaces for peripheral or accessory devices, or the connectors 230 may be removable and replaceable for maintenance and the like.

Now referring to FIG. 5, an external portion perspective view of the battery interface 200 is shown. In addition to the electronics housing 231, additional details of the example embodiments of the quick-release mechanism are shown. In this regard, the lever arm 220 and the lever arm 240 can be seen disposed overlapping of the battery 300 and the battery 500, respectively. The lever arm 220 may include a grasp lip 223 disposed at an end of the lever arm 220 that is distal from the hinge 224. As mentioned above and further described below, the lever arm 220 may pivot about an axis of the hinge 224 between a locked position (as shown in FIG. and an unlocked position. The lever arm 220 may be biased by springs 221 and 222 into the locked position to maintain the battery 300 in a secured connection with the battery interface 200. Similar to lever arm 220, lever arm 240 may include a grasp lip 243 disposed at an end of the lever arm 240 that is distal from the hinge 244. The lever arm 240 may also pivot about an axis of the hinge 244 between a locked position (as shown in FIG. 5) and an unlocked position. The lever arm 240 may also be biased by springs 241 and 242 into the locked position to maintain the battery 300 in a secured connection with the battery interface 200.

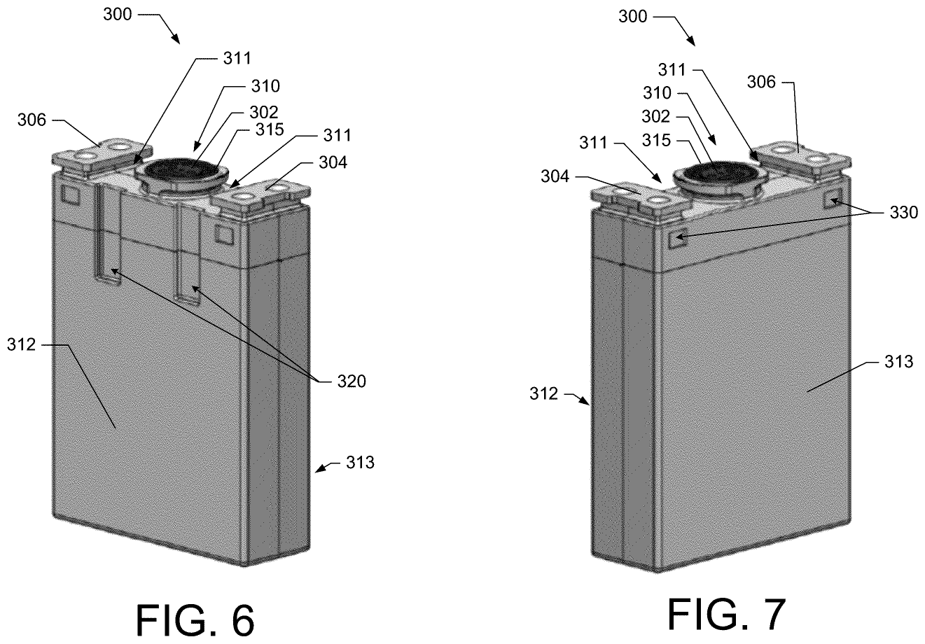

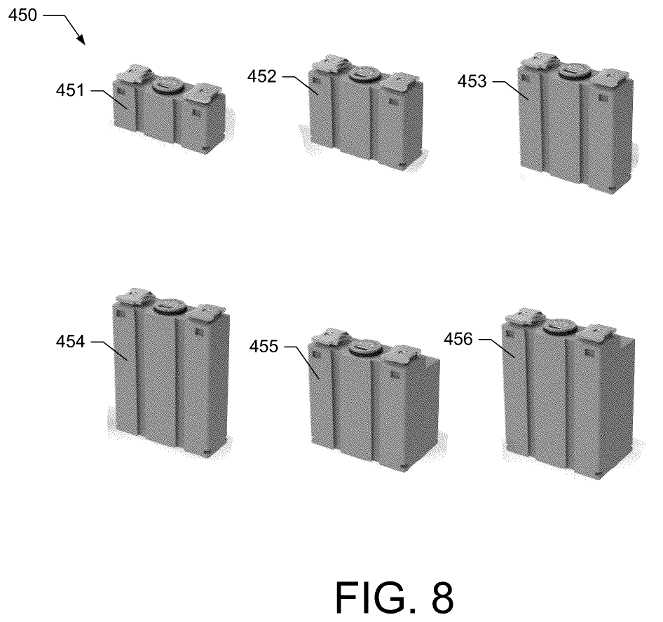

FIGS. 6 and 7 illustrate the example battery 300, according to some example embodiments. FIG. 6 illustrates the battery 300 as a perspective view of the battery internal side 312, and FIG. 7 illustrates the battery 300 as a perspective view of the battery external side 313. It is understood that the structure of the battery 300 is one example and that other battery structures may be implemented in according to various example embodiments of the battery interface 200. In this regard, the battery 300 may be formed as a rectangular cube shape having a battery internal side 312, a battery external side 313, and a battery front surface 310. As mentioned above, the battery internal side 312 may be disposed adjacent to the battery internal side support surface of the base 202 when the battery 300 is installed the receiving slot of the battery interface 200. The battery external side 313 may be disposed adjacent to the lever arm 220 when the battery 300 is installed in the receiving slot of the battery interface 200 and the lever arm 220 is in the locked position.

The battery internal side 312 may include one or more channels 320 for assisting with sliding the battery 300 into and out of an installed position. The channels 320 may align with corresponding rails on the battery internal side support surface of the base 202 of the battery interface 200. The engagement of the channels 320 with the rails of the battery interface 200 may operate to guide the battery 300 and retain the battery 300 within the receiving slot in the battery interface 200. According to some example embodiments, the channels 320 and rails may be dovetailed or otherwise have complementary shapes to prevent disengagement in a direction perpendicular to the battery internal side 312. It is understood that such channel and rail engagement can be used different configurations than that which is shown in FIGS. 6 and 7. For example, the channels may be disposed on the battery internal side support surface of the battery interface 200 and the rails may be disposed on the battery internal side 312 of the battery 300.

The battery external side 313 may include one or more complementary mechanical latch features that are aligned and configured to engage with a mechanical latch feature on the lever arm 220, as further described below. In this regard, the latch recesses 330 on the battery external side 313 may be complementary mechanical latch features that are aligned to engage with a mechanical latch feature in the form of a tab that is received into a latch recess 330 to prevent movement of the battery 300. As described herein, the battery 300 includes latch recesses 330 and the lever arm 220 includes tabs. However, it is understood that, in some example embodiments, any tab and latch recess configuration may be implemented, such as, for example, the battery 300 may include tabs and the lever arm 220 may include latch recesses that engage with the tabs.

According to some example embodiments, the battery front surface 310 may include a power connecter 302. The power connector 302 may include recessed plugs or extending pins to engage with a complementary battery interface connector on the battery interface 200. According to some example embodiments, the power connector 302 may be keyed to ensure that the power connector 302 is properly engaged with the complementary battery interface connector. According to some example embodiments, the power connector 302 may be surrounded by a seal 315 (e.g., an annular seal) that operates to seal the power connector 302 to a surface of the battery interface 200 to prevent debris and fluids from compromising the electrical connection made by the power connector 302. According to some example embodiments, the power connector 302 may be centrally located on the battery front surface 310.

According to some example embodiments, the battery 300 may also include complementary magnetic latch features. In this regard, according to some example embodiments, the complementary magnetic latch features may include magnets or a ferrous metal that can be attracted to a magnet. In the example embodiment shown in FIGS. 6 and 7, the battery 300 includes metal plates 304 and 306 that operate as complementary magnetic latch features. According to some example embodiments, the plates 304 and 306 may be disposed on the battery front surface 310. Further, according to some example embodiments, the battery 300 may include two complementary magnetic latch features in the form of plates 304 and 306 that are positioned on opposite sides of the power connector 302. Positioned in this manner, the plates 304 and 306 may contribute to a balanced magnetic bias when the plates 304 and 306 are aligned with respective magnets of the battery interface 200.

The power connector 302 and the plates 304 and 306 extend away or protrude from the battery front surface 310. Due to these protrusions, voids 311 are formed between the power connector 302 and the respective plates 304 and 306. As further described below, these voids 311 may receive an ejection cam that extends from the lever arm 220 when the battery 300 is installed in the battery interface 200 and the lever arm 220 is in the locked position.

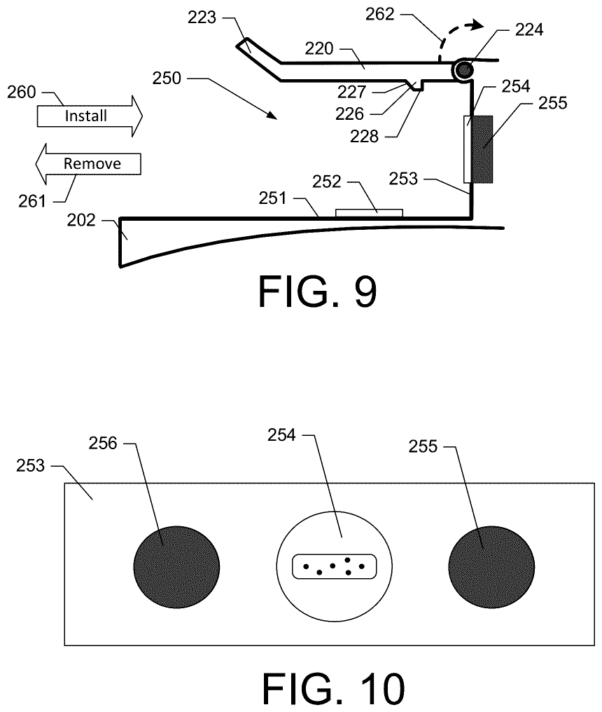

Now referring to FIG. 8, a collection of batteries 450 are shown that include the engaging features of battery 300, but the batteries are provided in different form factors. In this regard, the collection of batteries 450 include various batteries having different cell counts that therefore store different amounts of charge. The battery 451 may be a single cell battery, and the battery 452 may be a two-cell battery. The battery 453 may be three-cell battery, and the battery 454 may be a four-cell battery. The battery 455 may be a six-cell battery, and the battery 456 may be an eight-cell battery. Because each of the batteries within the collection of batteries 450 include similar engaging features with battery 300, any of the batteries within the collection of batteries 450 may be installed into the battery interface 200. This indicates the flexibility of the battery interface 200 to accept different batteries based on, for example, load or duration requirements for a given set of devices that are powered by the batteries installed in the battery interface 200. Additionally, for battery interfaces that secure two batteries, same-sized batteries may be used to for weight balancing.

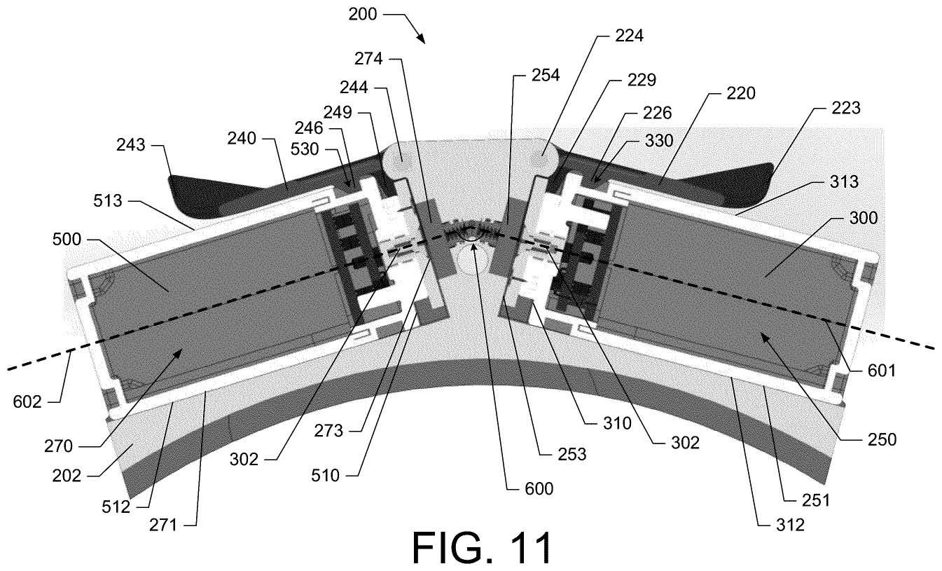

Having described various aspects of the battery interface 200 and the battery 300, FIG. 9 will now be described which shows a cross-section of a battery receiving slot 250 that is configured to receive and securely maintain a battery 300. In this regard, the battery receiving slot 250 may be defined by a void formed on its sides by a battery internal side support surface 251, the battery front support surface 253, and the lever arm 220. With respect to the battery receiving slot 250, the battery 300 may be installed in the direction of the install direction/arrow 260 and removed in the direction of the remove direction/arrow 261.

As mentioned above, the base 202 may include the battery internal side support surface 251 and the battery front support surface 253. The battery internal side support surface 251 may be a planar surface to complement the planar surface of the battery internal side 312. Additionally, the battery internal side support surface 251 may include one or more rails 252. The rails 252 may be protrusions from the battery internal side support surface 251 that engage with the channels 320 of the battery 300. As such, according to some example embodiments, the rails 252 may be formed in a dovetail shape to engage with a complementary dovetail channel 320 of the battery 300 to secure the battery 300 to the battery internal side support surface 251 in directions other than the install/remove directions.

The battery front support surface 253 may also be a generally planar surface that is configured to engage with the battery front surface 310. In this regard, the battery front support surface 253 may include a port 254 that is configured to physically and electrically interface with the power connector 302 of the battery 300. The port 254 may be one example of an electrical connection interface of the base 202. Additionally, the battery front support surface 253 may include one or more magnetic latch features. In this regard, for example, the magnetic latch features of the battery front support surface 253 may be one or more magnets including magnet 255. According to some example embodiments, the magnet 255 may be a permanent magnet that is affixed to the battery front support surface 253 at a location that aligns with a complementary magnetic latch feature (e.g., metal plate 304) of the battery 300. A magnetic bias (or force) may exist between the magnet 255 and the metal plate 304 that tends to pull or hold the battery 300 in the direction of the install direction/arrow 260. According to some example embodiments, to remove the battery 300 from the battery receiving slot 250, a force that overcomes the magnetic bias between the magnet 255 and the metal plate 304.

The lever arm 220 is also shown in FIG. 9. According to some example embodiments, the lever arm 220 may pivot about the hinge 224 from a locked position as shown in FIG. 9 to an unlocked position as indicated by the arrow 262. The lever arm 220 may also include a grasp lip 223 that is disposed at a distal end of the lever arm 220. The grasp lip 223 may extend away from a main body of the lever arm 220 at an angle away from an installed battery to create a void between the grasp lip 223 and the installed battery for receiving a user's fingers to facilitate grasping the lever arm 220.

Additionally, the lever arm 220 may include a mechanical latch feature that may be embodied as a tab 226. The tab 226 may be disposed on the interior or battery-side of the lever arm 220 to facilitate engagement with the battery to create a mechanical latch. In this regard, the tab 226 may be positioned on the lever arm 220 such that the tab 226 aligns with the complementary mechanical latch feature of the battery 300 that is embodied as a latch recess 330. As such, when a battery 300 is installed in the battery receiving slot 250, the tab 226 may be received into the latch recess 330 to mechanically secure the battery 300 in the installed position within the battery receiving slot 250. According to some example embodiments, the tab 226 may also include a ramped surface 227. Because in some example embodiments the lever arm 220 may be biased by a spring (e.g., springs 221 and 222) into the locked position, the ramped surface 227 allows a battery 300 to be slid into the battery receiving slot 250 without the tab 226 preventing movement in the install direction 260. In this regard, as the battery 300 comes into contact with the ramped surface 227 of the tab 226 during installation of the battery 300, the ramped surface 227 of the tab 226 will cause the tab 226 to ride up onto the battery external surface 313 and slide along the battery external surface 313 until the tab 226 is aligned with the latch recess 330. The tab 226 may that snap into the latch recess 330 under the urging caused by the spring. Because the surface 228 opposite the ramped surface 227 is disposed, for example, at a 90 degree angle, the surface 228 operates as a catch that engages with an internal surface within the latch recess 330 to prevent movement of the battery 300 in the remove direction 261, unless the lever arm 220 is lifted and the tab 226 moves out of the latch recess 330.

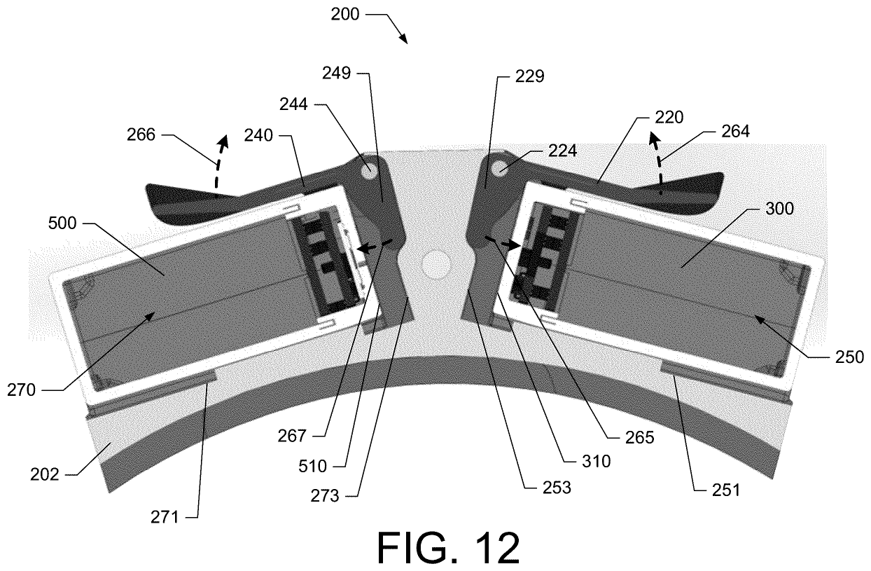

Now referring to FIG. 10, a front view of the battery front support surface 253 is shown. The battery front support surface 253 may be the surface that includes the port 254 for electrically and mechanically engaging with the battery front surface 310 and its power connector 302. As mentioned above, the battery front support surface 253 may also include one or more magnetic latch features. In this example embodiment, the magnetic latch features are embodied as permanent magnets 255 and 256. The magnets 255 and 256 may be positioned to align with the complementary magnetic latch features of the battery 300 embodied as metal plates 304 and 306. The combination of the magnets 255 and 265 with the plates 304 and 306 forms a magnetic latch that holds the battery 300 in the installed position due to the generated magnetic bias, even when the mechanical latch associated with the lever arm 220 is open or unlocked (e.g., the lever arm 220 is in the unlocked position and the tab 226 is not engaged with the latch recess 330).

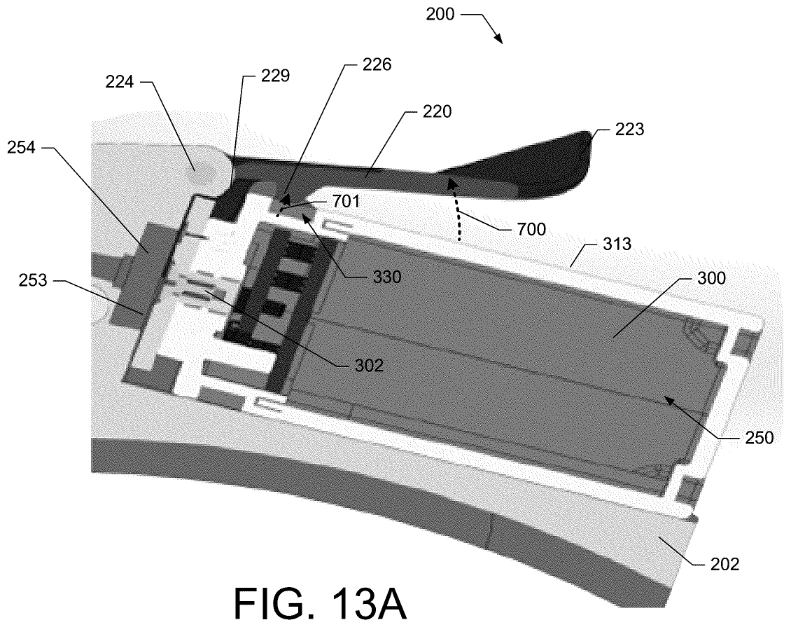

Now referring to FIG. 11, a top, cross-section view of the battery interface 200 is shown with batteries 300 and 500 installed. As mentioned above, the battery interface 200 may be configured to provide power from either or both of batteries 300 and 500, via ports 254 and 274, respectively. According to some example embodiments, the ports 254 and 274 may be configured to operate in parallel to allow one of the batteries 300 or 500 to be removed, while the other of the batteries remains installed to provide power continuity. As such, the battery interface 200 may be configured to provide parallel power output to permit replacement of either one the battery 300 or the battery 500 while maintaining power output to peripheral or accessory devices.

Additionally, as shown in FIG. 11, the lever arm 220 with grasp lip 223 has been pivoted via hinge 224 into the locked position where tab 226 is disposed within latch recess 330 and the lever arm 220 is positioned adjacent to the battery external side 313. With the battery 300 installed within the battery receiving slot 250, the battery internal side 312 is disposed adjacent the battery internal side support surface 251. Further, the power connector 302 of the battery 300 is physically and electrically engaged with the port 254, and the battery front surface 310 is disposed adjacent to the battery front support surface 253. Although somewhat obscured in this cross-section view, ejection cam 229 may be disposed between the battery front support surface 253 and the battery front surface 310.

Similarly, the lever arm 240 with grasp lip 243 has been pivoted via hinge 244 into the locked position where tab 246 is disposed within latch recess 530 and the lever arm 240 is positioned adjacent to the battery external side 513. With the battery 500 installed within the battery receiving slot 270, the battery internal side 512 is disposed adjacent the battery internal side support surface 271. Further, the power connector 502 of the battery 500 is physically and electrically engaged with the port 274, and the battery front surface 510 is disposed adjacent to the battery front support surface 273. Although somewhat obscured in this cross-section view, ejection cam 249 may be disposed between the battery front support surface 273 and the battery front surface 510.

Centerline 601 is defined through the battery receiving slot 250 (i.e., a center of the battery receiving slot 250 defining a first longitudinal direction of the battery receiving slot 250) and defines an angle upon which battery 300 is oriented when installed in the battery receiving slot 250. In this regard, the centerline 601 is parallel to the battery internal side support surface 251 and perpendicular to the battery front support surface 253. Similarly, centerline 602 is defined through the battery receiving slot 270 (i.e., a center of the battery receiving slot 270 defining a second longitudinal direction of the battery receiving slot 270) and defines an angle upon which battery 500 is oriented when installed in the battery receiving slot 270. In this regard, the centerline 602 is parallel to the battery internal side support surface 271 and perpendicular to the battery front support surface 273. As can be seen, according to some example embodiments, the centerlines 601 and 602, and therefore the orientations of the battery receiving slots 250 and 270, as well as the installed positioning of the batteries 300 and 500, are all non-parallel. Rather, the centerlines 601 and 602 form an angle 600 (i.e., an obtuse angle) therebetween. This positioning and orientation of the battery receiving slots 250 and 270 creates a more streamlined form factor for the battery interface 200 and also facilitates ease of interaction with the lever arms 220 and 240, as well as the batteries 300 and 500 during installation and removal.

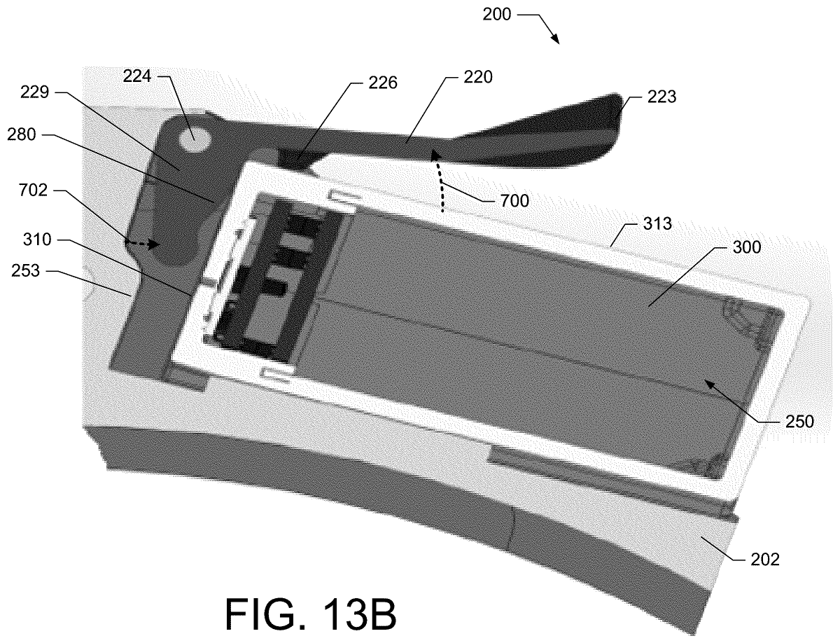

Now referring to FIG. 12, another top, cross-section view of the battery interface 200 at a more central depth (relative to FIG. 11) showing ejection cams 229 and 249 is provided with batteries 300 and 500 installed. The lever arm 220 is more clearly shown with ejection cam 229, which extends from a portion of the lever arm 220 at the hinge 224. The ejection cam 229 may be affixed to or integral with the lever arm 220, and the ejection cam 229 may include or be the same material as the lever arm 220. In this regard, the ejection cam 229 may extend from the lever arm 220 at an angle, e.g., about a ninety-degree angle, to the elongation of the lever arm 220. When the lever arm 220 is in the locked position as shown in FIG. 12, the ejection cam 229 may extend from the hinge interface on an exterior of the battery interface 200, along the battery front support surface 253 towards the battery internal side support surface 251. As such, with the lever arm 220 in the locked position and the battery 300 installed, the ejection cam 229 may be disposed between the battery front support surface 253 and the battery front surface 310. According to some example embodiments, the ejection cam 229, while the lever arm 220 is in the locked position, may extend into a void 311 as indicated in FIGS. 6 and 7. Additionally, according to some example embodiments, the battery front support surface 253 may be contoured to have a recess that receives at least a portion of the ejection cam 229 when the lever arm 220 is in the locked position. As further described below, pivoting of the lever arm 220 out of the locked position and into the unlocked position, as indicted by arrow 264, may cause the ejection cam 229 to pivot, as indicated by arrow 264, and apply a removal force on the battery front surface 310 to urge the battery 300 out of the battery receiving slot 250 against the magnetic bias of the magnetic latch (noting that pivoting of the lever arm 220 also disengages the mechanical latch).

Similarly, the lever arm 240 is more clearly shown with ejection cam 249, which extends from a portion of the lever arm 240 at the hinge 244. The ejection cam 249 may be affixed to or integral with the lever arm 240, and the ejection cam 249 may be or include the same material as the lever arm 220. In this regard, the ejection cam 249 may extend from the lever arm 240 at an angle, e.g., about a ninety-degree angle, to the elongation of the lever arm 240. When the lever arm 240 is in the locked position as shown in FIG. 12, the ejection cam 249 may extend from the hinge interface on an exterior of the battery interface 200, along the battery front support surface 273 towards the battery internal side support surface 271. As such, with the lever arm 240 in the locked position and the battery 500 installed, the ejection cam 249 may be disposed between the battery front support surface 273 and the battery front surface 510. According to some example embodiments, the ejection cam 249, while the lever arm 240 is in the locked position, may extend into a void for battery 500 similar to void 311 as indicated in FIGS. 6 and 7. Additionally, according to some example embodiments, the battery front support surface 273 may be contoured to have a recess that receives at least a portion of the ejection cam 249 when the lever arm 240 is in the locked position. As further described below, pivoting of the lever arm 240 out of the locked position and into the unlocked position, as indicted by arrow 266, may cause the ejection cam 249 to pivot, as indicated by arrow 267, and apply a removal force on the battery front surface 510 to urge the battery 500 out of the battery receiving slot 270 against the magnetic bias of the magnetic latch (noting that pivoting of the lever arm 240 also disengages the mechanical latch).

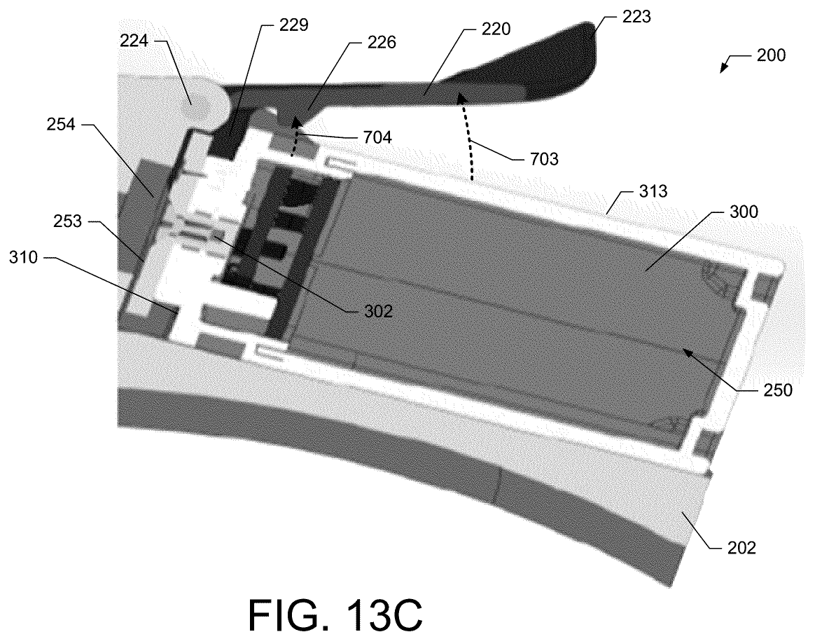

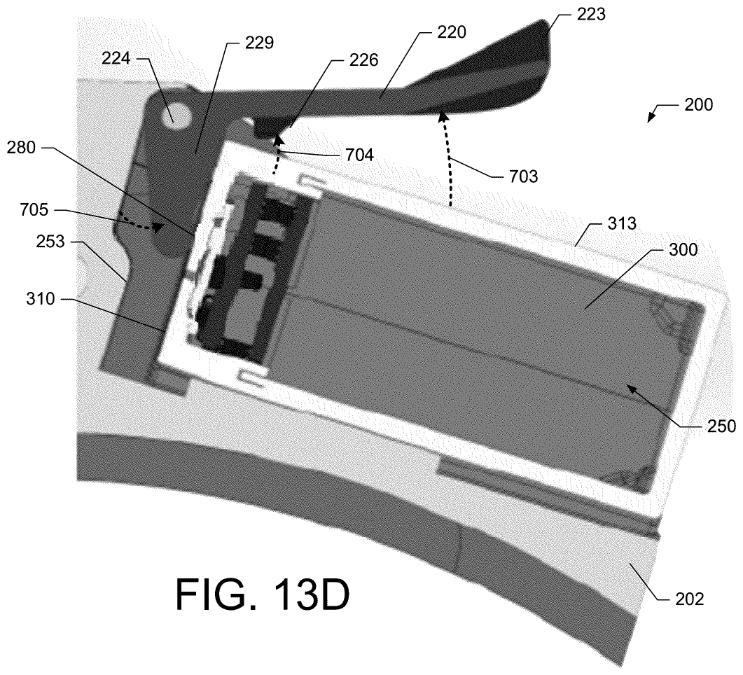

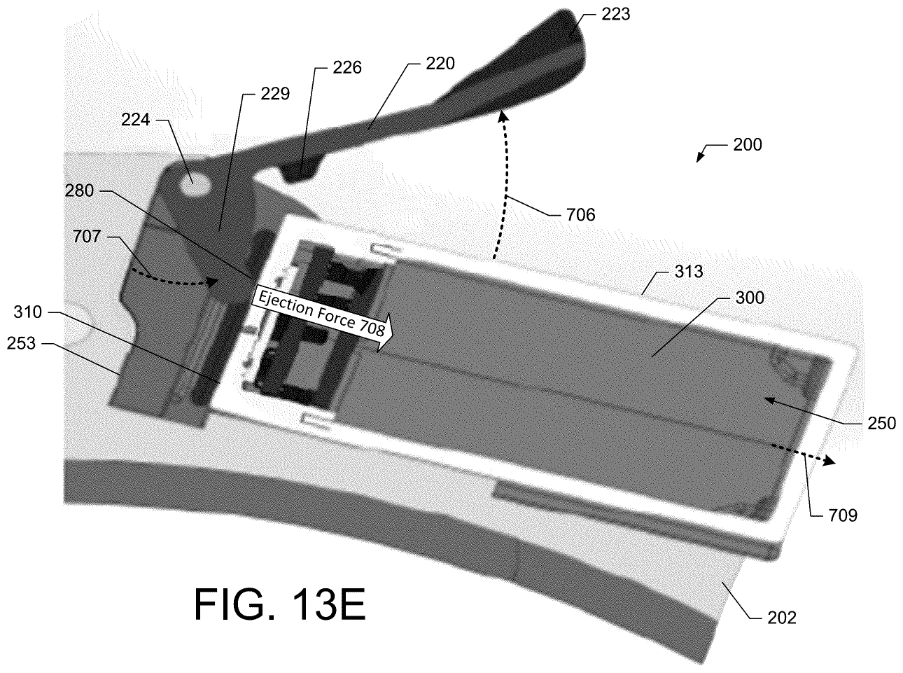

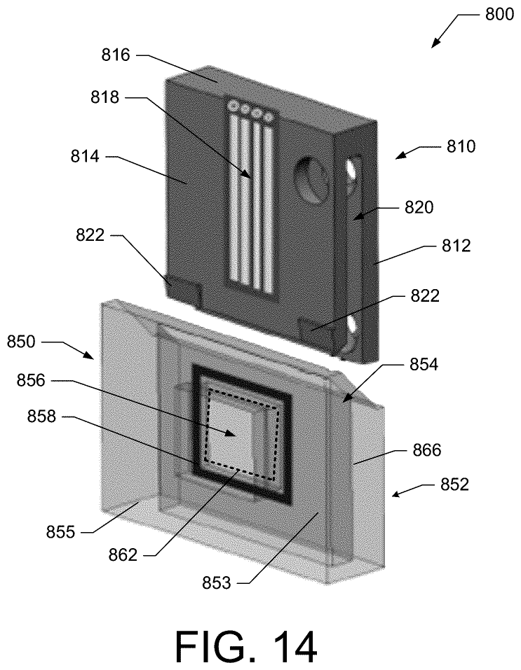

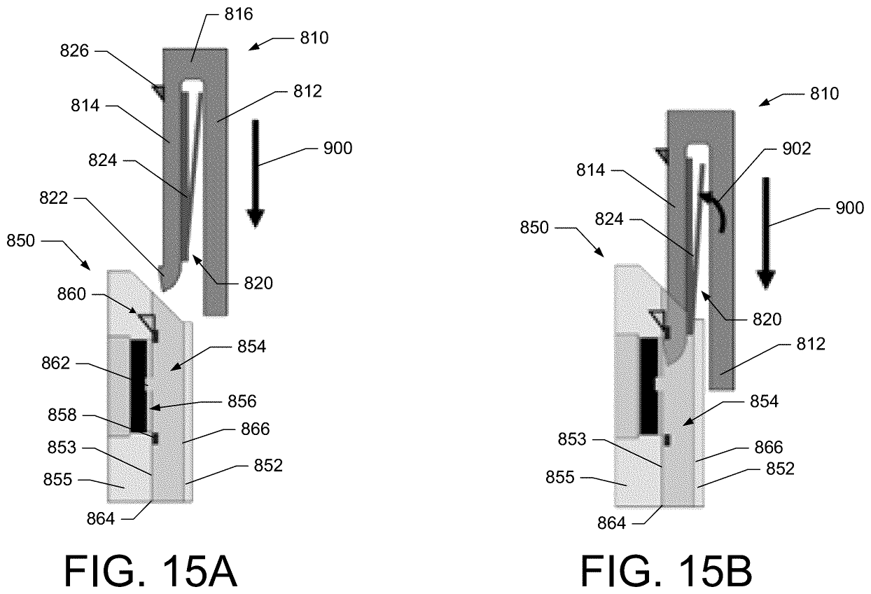

FIGS. 13A to 13E will now be described which show zoomed in top, cross-section views of incremental operations in a process of ejecting the battery 300 from the engagement with the port 254 and out of the battery receiving slot 250. Additionally, FIGS. 13A to 13E show the transition of the lever arm 220 as it moves from the locked position (where both the mechanical latch and the magnetic latch are securing the battery 300 in the battery receiving slot 250) to an unlocked position where the mechanical latch is no longer engaged and the battery 300 is being urged out of the battery receiving slot 250 by the ejection cam 229. Although features of a magnetic latch are not shown in FIGS. 13A to 13E, it is understood based on the description above, that the ejection of the battery 300 involves overcoming a magnetic bias that tends to pull the battery 300 into the battery receiving slot 250 toward the battery front support surface 253. To eject the battery 300, a user may pivot the lever arm 220 outwards, away from the battery 300, to simultaneously disengage the mechanical latch and cause the ejection cam 229 to push the battery 300 out of the battery receiving slot 250 against the magnetic bias of the magnetic latch.

In this regard, FIG. 13A provides a zoomed top, cross-section view of the battery receiving slot 250 of the battery interface 200 at a depth of the tab 226. The lever arm 220 has been lifted away from the battery external side 313 and pivoted about the hinge 224 as indicated by arrow 700. Since tab 226 is coupled to the lever arm 220, tab 226 moves, as indicated by arrow 701, with the lever arm 220 out of the latch recess 330 in the battery 300. Once the edge of the tab 226 clears the upper edge of the latch recess 330, the mechanical latch formed via the tab 226 and the latch recess 330 is disengaged. Now referring to FIG. 13B, a zoomed top, cross-section view of the battery receiving slot 250 of the battery interface 200 is provided in the same position as shown in FIG. 13A, however, now at a depth of the ejection cam 229. As such, due to the lever arm 220 having moved as indicated by arrow 700, the ejection cam 229, being coupled to the lever arm 220, has also moved away from the battery front support surface 253 and towards the battery front surface 310 as indicated by arrow 702.

FIG. 13C shows another zoomed top, cross-section view of the battery receiving slot 250 of the battery interface 200 at a depth of the tab 226. In FIG. 13C, the lever arm 220 has been lifted farther away from the battery external side 313 and further pivoted about the hinge 224 as indicated by arrow 703. Again, since tab 226 is coupled to the lever arm 220, tab 226 moves farther away from the latch recess 330, as indicated by arrow 704. As shown in FIG. 13C, the edge of the tab 226 has cleared the upper edge of the latch recess 330, and therefore, the mechanical latch formed via the tab 226 and the latch recess 330 is now disengaged. However, because the battery front surface 310 is still adjacent to the battery front support surface 253, the magnetic bias of the magnetic latch is strong enough to maintain the battery 300 in position, even without the mechanical latch engaged. According to some example embodiments, the magnetic bias may be strong enough to prevent removal of the battery 300 by hand without operating the lever arm 220 and the ejection cam 229 as further described below. As such, according to some example embodiments, the magnetic latch, in isolation, may be configured to hold the battery 300 in the battery receiving slot 250. Referring to FIG. 13D, a zoomed top, cross-section view of the battery receiving slot 250 of the battery interface 200 is provided in the same position as shown in FIG. 13C, however, now at a depth of the ejection cam 229. As such, the lever arm 220, having moved as indicated by arrow 703, has caused the ejection cam 229 to move farther away from the battery front support surface 253 as indicated by the arrow 705. Accordingly, an ejection surface 280 of the ejection cam 229, disposed on the battery-side of the ejection cam 229, has come into contact with the battery front surface 310 and is positioned to apply an ejection force on the battery front surface 310. Such ejection force may directed such that the ejection force urges the battery 300 against the magnetic bias of the magnetic latch formed by, for example, the magnets 255 and 256 and the plates 304 and 306. According to some example embodiments, the tab 226 and the ejection cam 229 may be coupled to the lever arm 220 such that the ejection surface 280 of the ejection cam 229 contacts the battery front surface 310 only after the tab 226 is disengaged from the latch recess 330. In this manner, the urging provided by the ejection cam 229 can operate to move the battery 300, since the mechanical latch is disengaged.

Continuing to FIG. 13E, which is another zoomed top, cross-section view of the battery receiving slot 250 of the battery interface 200 at a depth of the ejection cam 229, the lever arm 220 has now been moved even farther from the battery external side 313 as indicated by arrow 706. As a result, the ejection cam 229 has also moved farther, as indicated by arrow 707. The ejection force 708 applied by the ejection surface 280 on the battery front surface 310 moves the battery 300 in a direction 709 out of the battery receiving slot 250, disconnecting the power connector 302 from the port 254. According to some example embodiments, ejection cam 229 may be long enough to move the battery 300 away from the magnets 255 and 256 disposed at the battery front support surface 253 by a distance that reduces the magnetic bias to a threshold level that permits a user to grasp the battery 300 and readily remove it completely from the battery receiving slot 250.

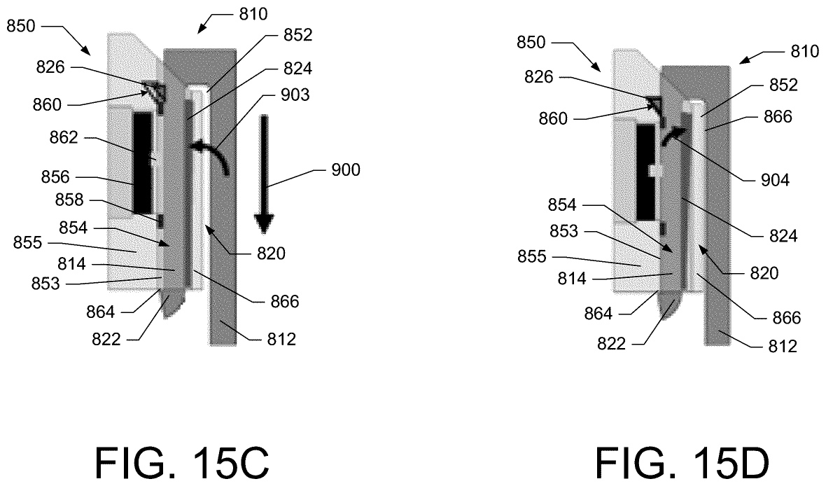

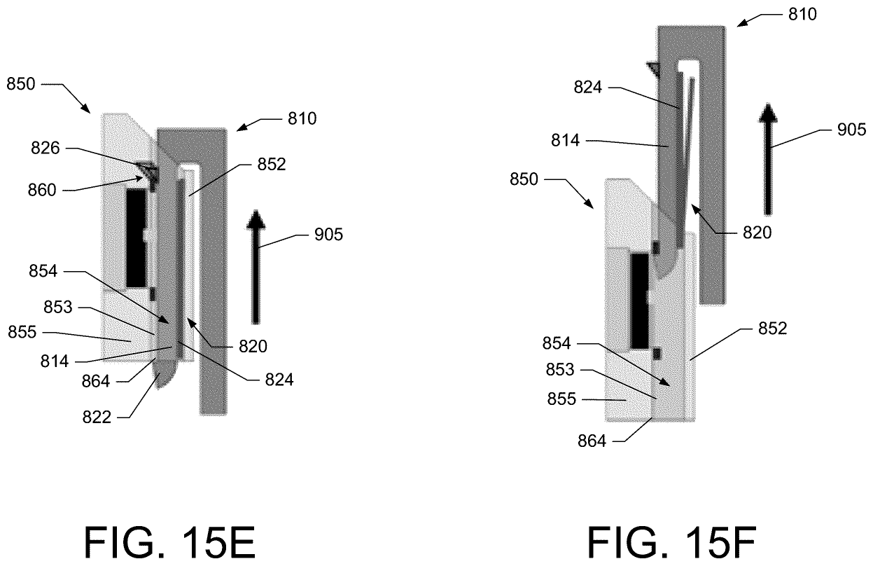

Having described various aspects specifically related to the battery interface 200, FIGS. 14 and 15A to 15F will now be described which illustrate a slot-based, electrical connection system, which may be referred to as a slot connection system 800 that can be implemented, for example, at positions on side rails of a helmet, such as side rails 402, with a portion of the slot connection system 800 being a connection slot 850. The connection slot 850 may be an example of the connection slots 404, 406, and 408 described above.

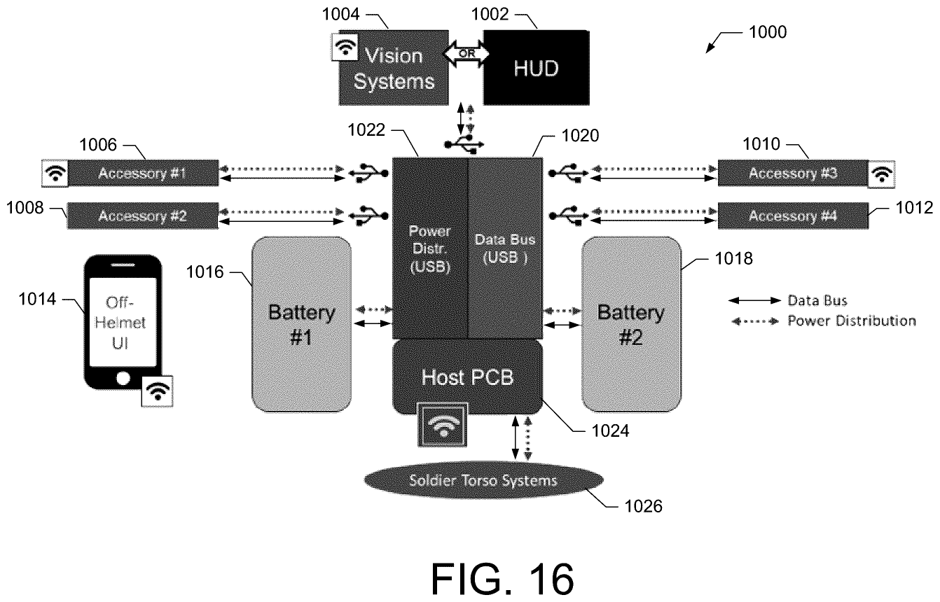

The slot connection system 800 may include a connection slot housing 850 and an accessory clip 810. The connection slot housing 850 may be component that is coupled to (e.g., affixed to or integrated with) a support structure of a helmet. For example, the connection slot housing 850 may be may be coupled to a side rail 402 as described above and may form one of a plurality of positions on the side rail 402 where accessory devices can be secured. The connection slot housing 850 may include a slot connector 862 that is electrically coupled to the battery interface 200, and, at least for power, to the electrical connection interface (e.g., port 254). In this regard, the slot connector 862 may be electrically connected to a power distribution system (e.g., power distribution system 1022 described with respect to FIG. 16) or a data bus (e.g., data bus 1020 described with respect to FIG. 16). Further, the slot connector 862, according to some example embodiments, provides a means for connecting an accessory device to the battery interface 200 via the power distribution system or data bus.

From a structural perspective, the connection slot housing 850 may include an internal slot 854 that is sized to receive a rear clip arm 814 of an accessory clip 810. According to some example embodiments, the internal slot 854 may be sized to conform to standards for the sizing of modular systems, such as MOLLE (MOdular Lightweight Load-carrying Equipment) systems that are commonly used on military backpacks and other wearable gear. Additionally, the sizing of the internal slot 854 may support operation as a component of a PALS (Pouch Attachment Ladder System)-type implementation.

According to some example embodiments, the internal slot 854 may be pass-through channel, such that the internal slot 854 is open at both a top and bottom ends. Further, the internal slot 854 may be defined at a front side by a front interior surface 866 of a front wall 852 and at a rear side by a rear interior surface 853 of a rear wall 855. The connector slot housing 850 may include a window 856 in the rear interior surface 853 that exposes the slot connector 862 to the internal slot 854. Via the window 856, a clip connector 818 may come into electrical contact with the slot connector 862 to connect an accessory device to the power distribution system or the data bus. Further, to maintain a high quality connection, a seal 858 may be affixed around the window 856 on the internal side. The seal 858 may be formed of a flexible material (e.g., rubber or the like) and may be operable to prevent debris and fluids from entering a space where the clip connector 818 is in contact with the slot connector 862. Additionally, the connector slot housing 850 may include one or more features configured to assist with retaining the accessory clip 810 in engagement with the connector slot housing 850. For example, a latch recess 860 may be formed in the rear interior surface 853, and, since the internal slot 854 may be pass-through, a bottom edge 864 of the connector slot housing 850 may also operate as a latching feature.

The accessory clip 810 may be, for example, a U-shaped component having a front clip arm 812 and a rear clip arm 814 that are connected via a bridge 816 to form a gap 820 between the front clip arm 812 and the rear clip arm 814. As further described below, the accessory clip 810 may be configured for secured engagement with the connector slot housing 850 by having the rear clip arm 814 of the accessory clip 810 slide into the internal slot 854 of the connector slot housing 850. The front clip arm 812 may slide in front of the front wall 852 of the connector slot housing 850, and the sliding operation may be stopped by the bridge 816 coming into contact with a top surface of the front wall 852.

The rear clip arm 814 of the accessory clip 810 may include the clip connector 818. The clip connector 818 may include a plurality of connection points or traces that are exposed on a rear surface of the rear clip arm 814 for connection with the slot connector 862 when the accessory clip 810 and the connector slot housing 850 are in an engaged position. The rear surface of the rear clip arm 814 may also include latching features that may operate to support a mechanical latched engagement between the accessory clip 810 and the connector slot housing 850. In this regard, for example, ramped latch protrusions 822 and 826 may be disposed on the rear surface of the rear clip arm 814. Additionally, the accessory clip 810 may include a spring 824. According to some example embodiments, the spring 824 may be a leaf spring that is disposed in the gap 820 between the front clip arm 812 and the rear clip arm 814. According to some example embodiments, the spring 824 may be affixed to a front surface of the rear clip arm 814 and the compressible leaf may have a pivot on an open end of the gap 820. The spring 824 may perform a securing function to urge the rear clip arm 814 towards the rear interior surface 853 of the connector slot housing 850 to increase engagement of the latching features on the rear interior surface 853 and the rear surface of the rear clip arm 814.

The front clip arm 812 may include physical connection features (e.g., screw holes, etc.) for securing the accessory clip 810 to an accessory device. Further, the accessory clip 810 may also include an accessory device connector (not shown) that is configured to electrically interface with the accessory device to provide a power or data connection from the accessory device to the clip connector 818.

FIGS. 15A through 15F illustrate cross-section view of an installation process for engaging the accessory clip 810 with connector slot housing 850 and removing the accessory clip 810 from the connector slot housing 850. As shown in FIG. 15A, the accessory clip 810 is not yet in contact with the connector slot housing 850, but is moving, as indicated by arrow 900, in a direction towards the connector slot housing 850 with the rear clip arm 814 aligned for entry into the internal slot 854. Since there is no contact between the accessory clip 810 and the connector slot housing 850, the spring 824 is fully deflected into the gap 820.

Now referring to FIG. 15B, the rear clip arm 814 has begun to enter the internal slot 854 due to the continued movement of the accessory clip 810 in the direction indicated by arrow 900. Because the rear clip arm 814 has entered the internal slot 854, the leaf of the spring 824 has begun to collapse as indicated by arrow 902 due to contact between the spring 824 and the front interior surface 866. FIG. 15C illustrates the accessory clip 810 in full engagement with the connector slot housing 850. The leaf of spring 824 is fully collapsed as indicated by arrow 903 and is therefore urging the rear clip arm 814 towards the rear interior surface 853 of the connector slot housing 850 to increase engagement of the latching features on the rear interior surface 853 and the rear surface of the rear clip arm 814. As such, ramped latch protrusion 826 is urged into engagement with latch recess 860 and ramped latch protrusion 822 is urged into engagement with bottom edge 864. With the accessory clip 810 in full engagement with the connector slot housing 850, the clip connector 818 is also in electrical contact with the slot connector 862.

To remove the accessory clip 810 from the connector slot housing 850, as shown in FIG. 15D, the user may apply a moment force as indicated by arrow 904 on the accessory clip 810 to further compress the leaf of the spring 824 and move the ramped latch protrusion 826 out of engagement with latch recess 860 and ramped latch protrusion 822 out of engagement with bottom edge 864. With these latches disengaged, the accessory clip 810 can be moved such that the rear clip arm 814 moves out of the internal slot 854 as indicated by direction/arrow 905 in FIG. 15E. With continued movement of the accessory clip 810 in the direction 905, the rear clip arm 814 may move farther out of the internal slot 854 and the leaf of spring 824 may deflect back into the gap 820 as shown in FIG. 15F. The accessory clip 810 may subsequently be completely removed from engagement with the connection slot housing 850, and the connector slot housing 850 may be ready to receive the same accessory clip 810 or another accessory clip associated with another accessory device.

FIG. 16 illustrates an example block diagram of the electronic components of a helmet system 1000 according to some example embodiments. In this regard, the helmet system 1000 may include or operate with example embodiments of the battery interface 200 and the power distribution system described herein. As shown in FIG. 16, the helmet system 1000 constructed with a power distribution system 1022 and a data bus 1020 as core components that operate to provide power to and link various electrical components. According to some example embodiments, the power distribution system 1022 and the data bus 1020 may operate in accordance with universal serial bus (USB) protocols to facilitate power delivery and data communications. According to some example embodiments, at least a portion of the power distribution system 1022 and the data bus 1020 may be constructed on a host PCB (printed circuit board) 1024. The host PCB 1024 may include various circuitry (e.g., processors, memory, radios, interface chips, passive devices, and the like) to control the provision of power from the batteries 1016 and 1018 to the various connected devices via the power distribution system 1022 and also the transmission and receipt of data between the various connected devices via the data bus 1020. According to some example embodiments, the host PCB 1024 may include a wireless communications interface (e.g., cellular, WI-FI®, BLUETOOTH®, or the like). The wireless communications interface may be implemented to communicate with, for example, a mobile terminal 1014 (e.g., smartphone) that may be configured to operate as an off-helmet user interface for the helmet system 1000. The host PCB 1024 may also include a wired communications and power interface for supporting communication with an external/off-helmet device 1026. The interface may additionally or alternatively provide power to or receive power from the external/off-helmet device 1026. An example of such an external/off-helmet device 1026 may be military devices that are configured as soldier torso systems. As indicated in FIG. 16, an external/off-helmet device 1026 may interface with the host PCB 1024 via both data (e.g., data bus 1020) or power (e.g., power distribution system 1022) connections.

The batteries 1016 and 1018 may be the same or similar to the batteries 300 and 500 described herein or those shown in FIG. 8. In this regard, the batteries 1016 and 1018 may be modular and rechargeable to allow for replacement, recharging, and reuse. According to some example embodiments, the batteries 1016 and 1018 may have on-board circuitry such as sensors (e.g., temperature sensors, current or voltage sensors, or the like), and, as such, the batteries 1016 and 1018 may have both a data and power connections to the host PCB 1024 to support both data exchange and provide power to the system.

Additionally, via the data bus 1020 and the power distribution system 1022, connections can be made to support the operation of a variety of peripheral and accessory devices. According to some example embodiments, peripheral devices may be permanently connected devices that are core to the operation of the helmet system 1000, while accessory devices may be interchangeable to tailor the helmet system 1000 for specific needs and applications. Examples of peripheral devices may include a heads up display (HUD) 1002 or another vision system 1004 (e.g., an augmented reality display that layers information over a real-world view of the user's environment, a night vision display, or the like) and possibly includes wireless communications capabilities. According to some example embodiments, such visual-based peripheral devices may be affixed to, for example, the helmet shell 103, at the front portion 101, such that the visual-based peripheral device can be extend down over the user's line of sight. As mentioned above, such visual-based peripheral devices may be heavy relative to other components of the helmet system 1000 and therefore positioning heavy batteries 1016 and 1018 at, for example, the rear portion 102 of the helmet 100 can counter-balance the weight of the helmet 100 and contribute to user neck comfort.

In addition to supporting the operation of such peripheral devices, the power distribution system 1022 and the data bus 1020 may also support the operation of accessory devices, such as accessory devices 1006, 1008, 1010, and 1012. Such accessory devices may be specialized devices designed for operation in certain scenarios. For example, such devices may include environmental sensors such as sensors that measure temperature, oxygen, radiation, or the like. Accessory devices may also include cameras, flashlights, lasers, navigation devices (e.g., global positioning system (GPS)), health sensors, specialized communications devices, or the like. Such accessory devices may be connected to the power distribution system 1022 and the data bus 1020 via accessory interface members, such as accessory interface members 400 and 401, and may use the slot connection system as described with respect to FIGS. 14 and 15A to 15F.

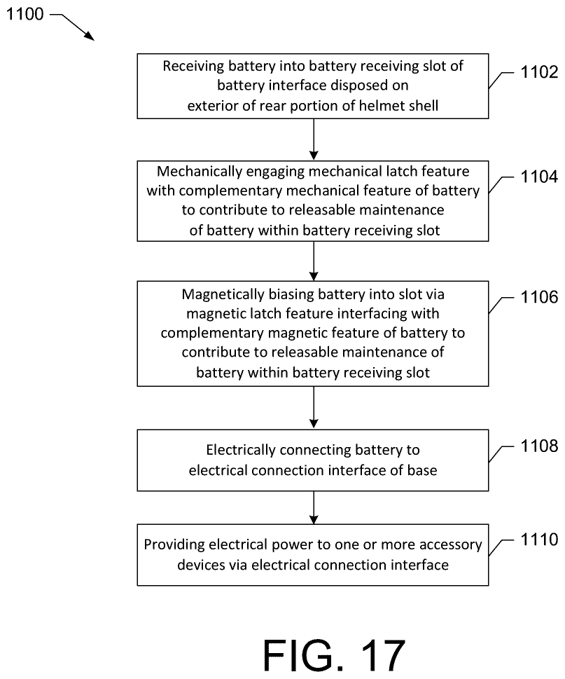

Now with reference to flowchart 1100 of FIG. 17, an example method for operating a helmet system for powering helmet-mounted electronic devices is provided. In this regard, according to some example embodiments, the example method may include, at 1102, receiving a battery into a battery receiving slot of a battery interface. According to some example embodiments, the battery receiving slot may be defined by a battery side support surface and a battery front support surface. The battery side support surface and the battery front support surface may be surfaces of a base of the battery interface, which may be disposed on an exterior of a rear portion of a helmet shell.

At 1104, the example method may include mechanically engaging a mechanical latch feature with a complementary mechanical feature of the battery to contribute to a releasable maintenance of the battery within the battery receiving slot. According to some example embodiments, the mechanical latch feature may be coupled to a lever arm that pivots to cause an ejection of the battery from the battery receiving slot. Additionally, at 1106, the example method may include magnetically biasing the battery into the slot via a magnetic latch feature (e.g., a magnet or a magnetic material) interfacing with a complementary magnetic feature (e.g., a magnet or a magnetic material) of the battery to contribute to the releasable maintenance of the battery within the battery receiving slot. According to some example embodiments, the magnetic biasing may hold the battery within the battery receiving slot without the mechanical latch feature being engaged with the complementary mechanical latch feature. Further, at 1108, the example method may include electrically connecting the battery to an electrical connection interface of the base, and, at 1110, the example method may include providing electrical power to one or more accessory devices via the electrical connection interface. In this regard, the one or more accessory devices may be supported by the helmet.

Having described various example embodiments, the following described some additional example embodiments as supported by the description above. In this regard, according to some example embodiments, a helmet system is provided. The helmet system may include a helmet shell and a battery interface. The helmet shell may include a front portion configured to be positioned adjacent a forehead of a head of a user and a rear portion configured to be positioned adjacent to a back of the head of the user. The battery interface may be disposed on an exterior of the rear portion of the helmet shell. The battery interface may include a base, a mechanical latch feature, and a magnetic latch feature. In this regard, the base may be disposed adjacent to the rear portion of the helmet shell. The base may include a battery internal side support surface, a battery front support surface, and an electrical connection interface configured to electrically connect to a battery. The battery internal side support surface and the battery front support surface may define a battery receiving slot. The mechanical latch feature may be configured to interface with a complementary mechanical feature of the battery to contribute to a releasable maintenance of the battery within the battery receiving slot. The magnetic latch feature may be configured to interface, via a magnetic bias, with a complementary magnetic feature of the battery to contribute to the releasable maintenance of the battery within the battery receiving slot.

Additionally, according to some example embodiments, the mechanical latch feature may physically engage the battery on an external side of the battery that is an opposite side of the battery to an internal side of the battery that is adjacent the battery internal side support surface. Further, the magnetic latch feature may apply the magnetic bias from the battery front support surface to a front surface of the battery. Additionally or alternatively, according to some example embodiments, the battery interface may further include a lever arm that is coupled to the mechanical latch feature. The lever arm may be configured to pivot into a locked position where the mechanical latch feature is engaged with the complementary mechanical feature of the battery, or an unlocked position where the mechanical latch feature is disengaged from the complementary mechanical feature. Additionally, the lever arm may further include an ejection cam. The ejection cam may be configured to apply an ejection force as the lever arm transitions from the locked position to the unlocked position to urge the battery, against the magnetic bias, away from the battery front support surface and out of electrical connection with the electrical connection interface. Additionally, according to some example embodiments, the magnetic latch feature may include a magnet disposed at the battery front support surface. Additionally or alternatively, according to some example embodiments, the lever arm may be configured to, when pivoting from the locked position to the unlocked position, simultaneously disengage the mechanical latch feature from the complementary mechanical feature and apply the ejection force onto the battery. Additionally or alternatively, according to some example embodiments, the battery receiving slot may be disposed between the lever arm and the battery internal side support surface.

Additionally or alternatively, according to some example embodiments, the battery interface may include a second base disposed adjacent to the rear portion of the helmet shell. The second base may include a second battery internal side support surface, a second battery front support surface, and a second electrical connection interface configured to electrically connect to a second battery. The second battery side support surface and the second battery front support surface may define a second battery receiving slot. The battery receiving slot may extend in a first longitudinal direction and the second battery receiving slot may extend in a second longitudinal direction. According to some example embodiments, the first longitudinal direction may be non-parallel to the second longitudinal direction. Additionally or alternatively, according to some example embodiments, the electrical connection interface and the second electrical connection interface may be configured to provide parallel power output to permit replacement of either one the battery or the second battery while maintaining power output to a peripheral or accessory device. Additionally or alternatively, according to some example embodiments, the helmet may further include a helmet side rail disposed on a side of the helmet shell. The helmet side rail may include a plurality of connection slots. A power distribution system that electrically connects the electrical connection interface to the plurality of connection slots may provide power to each of the connection slots. Further, each connection slot may be configured to mechanically support and electrically connect an interchangeable accessory device.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

What is claimed is:

1. A helmet system comprising:
a helmet shell comprising a front portion configured to be positioned adjacent to a forehead of a head of a user and a rear portion configured to be positioned adjacent to a back of the head of the user; and
a battery interface disposed on an exterior of the rear portion of the helmet shell,
wherein the battery interface comprises:
a base disposed adjacent to the rear portion of the helmet shell, the base comprising a battery internal side support surface, a battery front support surface, and an electrical connection interface configured to electrically connect to a battery, the battery internal side support surface and the battery front support surface defining a battery receiving slot;
a mechanical latch feature configured to interface with a complementary mechanical feature of the battery to contribute to a releasable maintenance of the battery within the battery receiving slot; and
a magnetic latch feature configured to interface, via a magnetic bias, with a complementary magnetic feature of the battery to contribute to the releasable maintenance of the battery within the battery receiving slot.

2. The helmet system of claim 1, wherein the mechanical latch feature physically engages the battery on an external side of the battery that is an opposite side of the battery to an internal side of the battery that is adjacent the battery internal side support surface; and
wherein the magnetic latch feature applies the magnetic bias from the battery front support surface to a front surface of the battery.

3. The helmet system of claim 1, wherein the battery interface further comprises a lever arm that is coupled to the mechanical latch feature,
wherein the lever arm is configured to pivot into
a locked position where the mechanical latch feature is engaged with the complementary mechanical feature of the battery, or
an unlocked position where the mechanical latch feature is disengaged from the complementary mechanical feature.

4. The helmet system of claim 3, wherein the lever arm further comprises an ejection cam,
wherein the ejection cam is configured to apply an ejection force as the lever arm transitions from the locked position to the unlocked position to urge the battery, against the magnetic bias, away from the battery front support surface and out of electrical connection with the electrical connection interface.

5. The helmet of claim 4, wherein the magnetic latch feature comprises a magnet disposed at the battery front support surface.

6. The helmet of claim 3, wherein the lever arm is configured to, when pivoting from the locked position to the unlocked position, simultaneously disengage the mechanical latch feature from the complementary mechanical feature and apply an ejection force onto the battery.

7. The helmet of claim 3, wherein the battery receiving slot is disposed between the lever arm and the battery internal side support surface.

8. The helmet of claim 1, wherein the battery interface comprises a second base disposed adjacent to the rear portion of the helmet shell, the second base comprising a second battery internal side support surface, a second battery front support surface, and a second electrical connection interface configured to electrically connect to a second battery, the second battery side support surface and the second battery front support surface defining a second battery receiving slot, wherein
the battery receiving slot extends in a first longitudinal direction and the second battery receiving slot extends in a second longitudinal direction, and
the first longitudinal direction is not parallel to the second longitudinal direction.

9. The helmet of claim 8, wherein the electrical connection interface and the second electrical connection interface are configured to provide parallel power output to permit replacement of either one the battery or the second battery while maintaining power output to a peripheral or accessory device.

10. The helmet of claim 1 further comprising:
a helmet side rail disposed on a side of the helmet shell, the helmet side rail comprising a plurality of connection slots; and
a power distribution system that electrically connects the electrical connection interface to the plurality of connection slots to provide power to each of the connection slots,
wherein each connection slot is configured to mechanically support and electrically connect an interchangeable accessory device.

11. A battery interface apparatus for a wearable device, the battery interface apparatus comprising:
a first base comprising a first battery internal side support surface, a first battery front support surface, and a first electrical connection interface configured to electrically connect to a first battery, the first battery internal side support surface and the first battery front support surface defining a first battery receiving slot;
a mechanical latch feature configured to interface with a complementary mechanical feature of the first battery to contribute to a releasable maintenance of the first battery within the first battery receiving slot; and
a magnetic latch feature configured to interface, via a magnetic bias, with a complementary magnetic feature of the first battery to contribute to the releasable maintenance of the first battery within the first battery receiving slot.

12. The battery interface apparatus of claim 11, wherein
the mechanical latch feature physically engages the first battery on an external side of the first battery that is an opposite side of the first battery to an internal side of the first battery that is adjacent the first battery internal side support surface, and
the magnetic latch feature applies a magnetic force from the first battery front support surface to a front surface of the first battery.

13. The battery interface apparatus of claim 11, further comprising a lever arm that is coupled to the mechanical latch feature, wherein
the lever arm is configured to pivot into
a locked position where the mechanical latch feature is engaged with the complementary mechanical feature of the first battery, or
an unlocked position where the mechanical latch feature is disengaged from the complementary mechanical feature.

14. The battery interface apparatus of claim 13, wherein the lever arm further comprises an ejection cam,
wherein the ejection cam is configured to apply an ejection force as the lever arm transitions from the locked position to the unlocked position to urge the first battery, against the magnetic bias, away from the first battery front support surface and out of electrical connection with the first electrical connection interface.

15. The battery interface apparatus of claim 14, wherein the magnetic latch comprises a magnet disposed at the first battery front support surface.

16. The battery interface apparatus of claim 13, wherein the first battery receiving slot is disposed between the lever arm and the first battery internal side support surface.

17. The battery interface apparatus of claim 13, wherein the lever arm is configured to, when pivoting from the locked position to the unlocked position, simultaneously disengage the mechanical latch feature from the complementary mechanical feature and apply an ejection force onto the first battery.

18. The battery interface apparatus of claim 11, further comprising a second base disposed adjacent to a rear portion of a helmet shell, the second base comprising a second battery internal side support surface, a second battery front support surface, and a second electrical connection interface configured to electrically connect to a second battery, the second battery side support surface and the second battery front support surface defining a second battery receiving slot, wherein
the first battery receiving slot extends in a first longitudinal direction and the second battery receiving slot extends in a second longitudinal direction, and
the first longitudinal direction is not parallel to the second longitudinal direction.

19. The battery interface apparatus of claim 18, wherein the first electrical connection interface and the second electrical connection interface are configured to provide parallel power output to permit replacement of either the first battery or the second battery while maintaining power output to a peripheral or accessory device.

20. A method for operating a helmet system for powering helmet-mounted electronic devices, the method comprising:
receiving a battery into a battery receiving slot defined by a battery side support surface and a battery front support surface, the battery side support surface and the battery front support surface being surfaces of a base of a battery interface disposed on an exterior of a rear portion of a helmet shell;
mechanically engaging a mechanical latch feature with a complementary mechanical feature of the battery to contribute to a releasable maintenance of the battery within the battery receiving slot;
magnetically biasing the battery into the slot via a magnetic latch feature interfacing with a complementary magnetic feature of the battery to contribute to the releasable maintenance of the battery within the battery receiving slot;
electrically connecting the battery to an electrical connection interface of the base; and
providing electrical power to one or more accessory devices via the electrical connection interface, the one or more accessory devices being supported by the helmet.
